(19) United States
(12) Patent Application Publication
(10) Pub. No.: US 2006/0288414 A1
(43) Pub. Date: Dec. 21, 2006

(54) Method and system for preventing virus infection

(75) Inventor: Naoto Kuroda, Nagano-ken (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 10/549,892

(22) PCT Filed: Mar. 17, 2004
(86) PCT No.: PCT/JP04/03520

§ 371 Date: Aug. 10, 2006

(30) Foreign Application Priority Data
Mar. 17, 2003 (JP) 2003-072371

(51) Int. Cl. G06F 12/14

(52) U.S. Cl. 726/24

(57) ABSTRACT

There is disclosed a system for detecting virus infection in a network and preventing the virus infection. Decoy means (13, 14, 15) accessible through the network (1) are arranged on a storage unit (12). The system comprises a communication information analysis means (16) that detects virus intrusion into the decoy means (13, 14, 15), and upon detection of the virus intrusion, detecting a computer as a source of the virus based on the communication information acquired upon the virus intrusion; and a computer attack means (17) that performs antivirus attack processing on the virus source computer through the network for suppressing action of the virus. Attack by the computer attack means (17) of a monitoring computer (10) is continued until the infected computer (5) is identified and the virus is removed by the administrator.

The entire disclosure of Japanese Patent Application No. 2003-072371 filed Mar. 17, 2003 is expressly incorporated by reference herein.

### TECHNICAL FIELD

The present invention relates to a technique of finding a source of infection when a computer connected to a network is infected with a virus, to prevent spreading of infection to other computers connected to the network.

### BACKGROUND ART

Some computer viruses intrude into a shared folder of a computer such as a server and access certain files or programs to demolish them or to rewrite them causing their malfunction. Using a certain program, it is possible to detect existence of a virus. Such a program identifies a virus based on a file name of the virus, a behavioral pattern of the virus, and the like. When a virus is detected, an administrator of the computer takes a necessary measure to remove the virus. Various techniques of detecting viruses and distributing a vaccine have been disclosed (See Patent Document 1: Japanese Non-examined Patent Laid-open No. 2002-259149).

The conventional techniques as described above have the following problems to be solved.

Namely, when a virus is detected, it is necessary to find an existing place of the virus quickly, to separate the virus from a network, and to disinfect the virus using a vaccine. Sometimes, however, it takes a lot of time from detection of a virus to completion of taking an antivirus countermeasure. In that case, it is feared that damage spreads widely to one computer after another, resulting in a lot of damage to the network.

Further, as for a virus that lies hidden in a computer on a network and accesses files on another computer through the network, sometimes it is difficult to detect the virus before the virus starts to act. Even in the case where the virus starts to act and then the virus is detected, damage will spread widely if it takes time to identify the computer in which the virus lies hidden and to disinfect the virus.

### DISCLOSURE OF THE INVENTION

An object of the present invention is to find out virus infection of a computer connected to a network and to prevent spread of damage to other computers connected to the same network.

A first mode of the present invention provides a method of preventing virus infection by detecting the virus infection in a network, comprising steps of: providing a decoy accessible through the network to a computer that monitors intrusion of a virus; receiving access to the decoy through the network, to obtain communication information and to detect intrusion of the virus; detecting a virus source computer based on the communication information obtained with respect to the virus intrusion when the virus intrudes into the decoy; and making an antivirus attack on the virus source computer through the network for suppressing operation of the virus.

A second mode of the present invention provides a system for preventing virus infection by detecting the virus infection in a network, comprising: a decoy means that can be accessed through the network; a communication information analysis means that detects intrusion of a virus into the decoy means, and then on detecting virus intrusion, detects a virus source computer based on communication information obtained when the virus intrudes; and a computer attack means that makes an antivirus attack on the virus source computer through the network, for suppressing operation of the virus.

A third mode of the present invention provides a system for preventing virus infection by detecting the virus infection in a network, comprising: a request receiving means that receives a request for making an antivirus attack on a virus source computer; and a computer attack means that makes an antivirus attack on the virus source computer through the network for suppressing operation of a virus, based on the request received.

A fourth mode of the present invention provides a program for making a computer prevent virus infection by detecting the virus infection in a network, wherein: the program makes the computer realize: a communication information analysis means that detects intrusion of a virus into a decoy means accessible through the network, and then on detecting virus intrusion, detects a virus source computer based on communication information obtained when the virus intrudes; and a computer attack means that makes an antivirus attack on the virus source computer through the network, for suppressing operation of the virus.

And, a fifth mode of the present invention provides a program for making a computer prevent virus infection by detecting the virus infection in a network, wherein: the program makes the computer perform processing of rejecting communication from a virus source computer when a network address of the virus source computer is notified.

### BRIEF DESCRIPTION OF DRAWINGS

FIG. 1 is a block diagram showing an example of a system for preventing virus infection;

FIG. 2 is an explanatory view showing examples of detection report;

FIG. 3 is an explanatory diagram showing an example of attacking an infected computer from a plurality of computers;

FIG. 4 is an explanatory diagram showing a large scale computer network;

FIG. 5 is a flowchart showing basic operation of a monitoring computer; and

FIG. 6 is a flowchart showing cooperative operation of a monitoring computer.

### BEST MODE FOR CARRYING OUT THE INVENTION

Now, will be described an outline of the best mode for carrying out the invention as well as its principle. Then, details will be described.

A decoy that can be accessed through a network is provided on a computer (a monitoring computer) that monitors virus intrusion. Access to the decoy is received through the network to obtain communication information and to detect virus intrusion. When a virus intrudes into the decoy, a computer as the source of the virus is detected based on the communication information obtained in association with the virus. Then, an antivirus attack process for suppressing operation of the virus is performed through the network against the virus source computer (infected computer). Further, a detection report is sent to an administrator of the virus source computer.

Here, a computer having low security is prepared as the decoy to prompt virus intrusion. To realize the lower security of the decoy, the decoy is made to have lower security than the computers whose protection against viruses is intended. However, it is difficult to examine whether the decoy has lower security than the other computers. Thus, it can be considered to discriminate security according to a level of a virus countermeasure. For example, it can be considered to employ no virus countermeasure that should be taken usually. In detail, may be mentioned, for example, no installation of antivirus software, disablement of installed antivirus software, and leaving a security hole, if any, of an operating system or an application untreated.

In many cases where an antivirus countermeasure is taken for a specific group of computers, the respective security levels of the computers to be protected are known. In that case, the security of the decoy is set to a level lower than the lowest among the security levels of the computers to be protected. As a result, it is arranged that a virus can intrude into the decoy most easily among the group of computers to be protected against viruses.

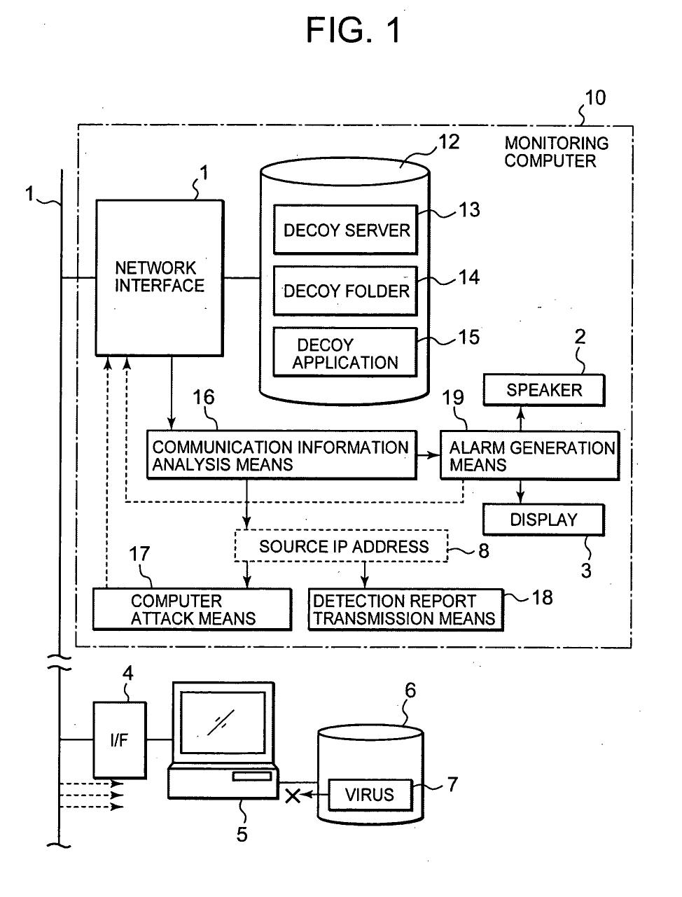

As the decoy, may be provided, for example, a decoy folder 14, a decoy application 15, a decoy server 13 or the like as shown in FIG. 1. One of them may be used by itself. Or, two or more of them may be used together. Further, decoys may be prepared being distributed among a plurality of computers.

The decoy folder 13 can be realized by an application provided in a decoy server that is formed virtually in a storage unit 12 of a computer 10 connected to a network 1. Virus intrusion into a folder means that a virus reads or tries to rewrite any file in the folder through a network. Virus infection means that a virus itself is taken into a some location of a storage unit of a computer.

Communication information means information (such as a communication path) received from the network when a virus intrudes into a decoy folder. Communication information includes a network address of the virus source computer, and the like. The virus source computer is a computer infected by the virus. By awaiting a virus using a decoy folder, it is possible to detect a virus that is intruding. A content of a detection report can be determined freely. Also, a reporting method can be selected freely. Just as a report is sent to an administrator of an infected computer, the computer as the source of infection is attacked.

Sometimes, a virus to be searched for is one that has the property of intruding into a shared folder. By preparing a decoy folder, it is possible to detect activity of such a virus having the property of intruding into a shared folder.

The decoy application 15 is realized as an application provided in a decoy server that is formed virtually in the storage unit of a computer connected to a network. This decoy is prepared for detecting a virus having the property of intruding into a server. A decoy application is prepared instead of a decoy folder. For example, in the case where a virus to be searched for is a virus having the property of causing malfunction of an application, it is possible to detect activity of such a virus by preparing a virtual decoy application.

The decoy server 13 is used for detecting a virus having the property of intruding into a server. A decoy server is realized by a virtual application, and has data that shows appearance of a server configuration. The decoy server 13 functions such that, when access to the decoy server 13 occurs, the decoy server 13 returns a response similar to a response of an actual server. Here, it is sufficient if the server type supposed is one that can become an object of access. For example, a web server or a mail server may be mentioned. Either type is satisfactory. This decoy server is prepared to cope with a virus of an anti-server type. Since it is arranged that a decoy folder is provided in the decoy server that is formed virtually in a storage unit of a computer, attack by a virus does not produce an effect. In other words, damage is not caused. At the same time, it is possible to find out the source of the attack while being attacked. A decoy server and a decoy folder may be independent of each other, or may be realized by an integrated application.

When a virus intrudes into a decoy, the source of infection is found out promptly, spreading of damage is prevented, and then a countermeasure is taken. Namely, an antivirus attack process for suppressing the operation of the virus is performed against the infected computer. As the antivirus attack process, may be mentioned sending of information for imposing a high load through a network. Such attack is continued until virus disinfection is completed. An antivirus countermeasure means separating an infected computer from a network, or exterminating the virus.

As a mode of attack seen from the subject, may be mentioned a single attack, a solicited attack, or a joint attack. A single attack means that a monitoring computer by itself attacks an infected computer. A solicited attack means that a monitoring computer requests a computer (which is near an infected computer and capable of attacking the infected computer) to attack the infected computer and the requested computer makes the attack. And, a joint attack means that a plurality of computers attack an infected computer. Details of these modes will be described later. Further, in the cases of the solicited attack and the joint attack, a monitoring computer may determine the method of attacking so that attack is made in a unified manner. Or, a monitoring computer may request the requested computer or each of the partner computers to make attack based on its attacking ability.

As a content of attack, the present invention employs a method of imposing a high communication load on an infected computer to suppress or prevent operation of the virus in the infected computer as described above, or a method of imposing a high load on a CPU of an infected computer. Either one or combination of these two methods may be used. Details of attack will be described later.

When an infected computer (i.e., a virus source) is detected, then first, a detection report is sent to an administrator of the infected computer. After that, attack on the infected computer is continued until an antivirus countermeasure is completed.

Further, at attacking the infected computer, a message announcing a start of the attack is sent to the infected computer to attract attention of the user or the administrator of the infected computer. Further, at the start of attack or thereafter, the attacking terminal unit produces an alarm sound. By this, it is possible to attract attention of users of other terminal units that share the network with the infected computer. The alarm sound may be of any type. Further, a message “attacking is going on” may be displayed on a display unit.

To make an attack, it is arranged that the requested computer or each of the computers participating in the attack, to say nothing of the monitoring computer, has an attacking program (an antivirus program) for making the computer in question execute processing of imposing a load on a virus source computer. Or, it may be arranged that the monitoring computer installs the antivirus program on another computer as the need arises.

Further, it is sufficient that a computer participating in attack other than the monitoring computer has a function of attacking. Thus, it does not matter if such a computer does not have the monitoring function.

On the other hand, a measure for protecting computers other than an infected computer is prepared in advance. For example, it is arranged that a computer performs processing of rejecting communication from a virus source computer when the network address of the virus source computer is notified. Or, for the purpose of protection, a computer performs processing of rejecting communication from a virus source computer when a notification of the infected computer is received from the network monitoring computer.

Next, will be described embodiments of the present invention referring to the drawings.

FIG. 1 is a block diagram showing an example of an antivirus system. A network 1 is connected with a computer 5 through a network interface 4. The computer 5 is provided with a storage unit 6. It is assumed that the storage unit 6 is infected with a virus 7. The computer is referred to as an infected computer.

The network 1 is connected with a monitoring computer 10. The monitoring computer 10 is provided with a network interface 11 and a storage unit 12. The storage unit 12 stores a decoy server 13, a decoy folder 14 and a decoy application 15. The computer 10 is provided with a communication information analysis means 16 for monitoring communication information acquired through the network interface 11 as a function realized by the computer 10. Output of the communication information analysis means 16 drives an alarm generation means 19. Further, it is arranged that a computer attack means 17 and a detection report transmission means 18 operate based on the output of the communication analysis means 16. The communication information analysis means 16, the computer attack means 17, the detection report transmission means 18 and the alarm generation means 19 are computer programs that are executed by a CPU (not shown) of the computer 10 so that the computer performs predetermined processing. These programs are installed onto the storage unit 12, and each loaded to the CPU (not shown) at the time of execution.

According to the present invention, the computer 5 infected with the virus 7 is identified, and a high load is imposed on the computer 5 to suppress operation of the virus 7 until an administrator of the computer 5 removes the virus 7. To identify the computer 5 infected with the virus 7, the decoy server 13, the decoy folder 14 and the decoy application 15 are provided in the network 1. The decoy server 13 and so on are formed virtually in the monitoring computer 10. Favorably, the decoy folder 14 is formed at any location in the storage unit 12 of the monitoring computer 10. Further, the decoy folder 14 is formed in and integrally with the decoy server 13.

[Decoy Server etc.]

It is favorable that the configuration of the decoy server 13 is determined such that a virus 7 attacks the decoy server 13 first of all on the network 1. To that end, the decoy server 13 is made to have the lowest security level, and, for example, the computer name of the decoy server 13 is selected such that the decoy server 13 is displayed at the top of the network computer list. Further, the name of the shared folder for receiving a virus is determined such that a virus easily attacks the shared folder. In this case also, a name that is displayed at the top of the shared folder name may be selected. Further, it is favorable to determine the best computer name and the best folder name considering virus properties. For example, the decoy server 13 is realized by an application program that operates in the same way as an actual server responds to an attempt of a virus 7 to intrude. Since the decoy server 13 is different from an actual server, destructive activity has no effect on the decoy server 13. For example, the folder 14 is realized by an application program that operates so as to respond in the same way as an actual folder responds to access of a virus 7. Since the folder 14 is different from an actual folder, destructive activity such as deletion of file has no effect on the folder 14. The decoy application 15 is different from an actual application, and there is no possibility that malfunction is caused.

[Identification of Infected Computer]

The communication information analysis means 16 functions such that, when intrusion of a virus is detected, the communication information analysis means 16 immediately analyzes and identifies the computer name of the source based on the communication information of the intrusion. The communication information includes information such as who has logged on to the computer, what address the computer has, what employee code the employee using the computer has, and the like.

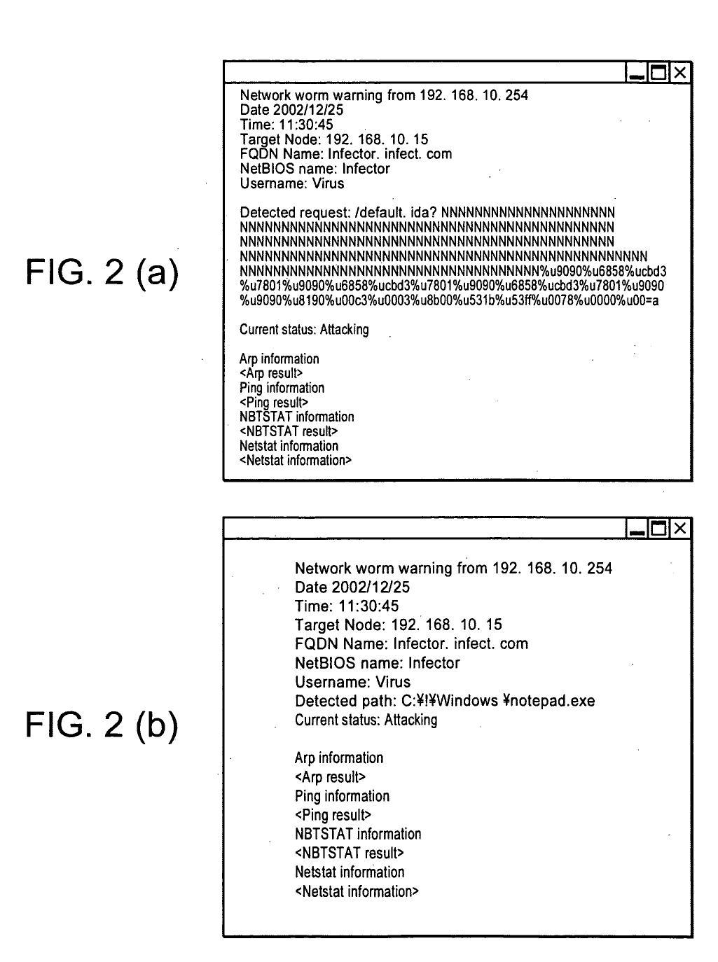

In the case where a computer virus is detected, unconditional and immediate attack on an infected computer causes various harmful influences since the user of the infected computer is perplexed. To avoid this, the alarm generation means 19 is provided. The alarm generation means 19 has a function of sending a message such as “This computer is infected with a virus. Please disconnect the computer from the network promptly” announcing a start of a countermeasure to the infected computer, using an advising means such as a pop-up message. Further, the alarm generation means 19 has a function of, for example, making a speaker 2 sound or displaying an alarm screen on a display 3, to give a warning to the effect that the virus 7 may intrude through the network, to users of computers in the neighborhood FIGS. 2(a) and 2(b) are explanatory views showing examples of detection report. The communication information analysis means 16 (See FIG. 1) transfers the source IP address 8 acquired from the communication information to the detection report transmission means 18. The detection report transmission means 18 sends the detection report to the administrator of the infected computer 5 via E-mail of facsimile, for example. FIG. 2(a) shows an example of detection report in the case where a diffusion-type virus has been detected. FIG. 2(b) shows an example of detection report in the case where a network-sharing-type virus has been detected. For example, FIG. 2(a) shows a report that the virus having the shown pattern is attacking the computer at the IP address “192.168.10.15”.

[Virus Intrusion and Detection of Infected Computer]

When a virus is taken in a computer on a network, the virus starts its operation with prescribed timing. For example, a virus accesses a shared folder of another computer through a network, and rewrites or demolishes a file stored in the shared folder. Thus, virus intrusion means behavior of accessing a shared folder. It is not necessarily true that a virus file is copied actually. As a result, in an ordinary state, it is not possible to distinguish file access of virus intrusion from normal file access, and thus sometimes it is impossible to detect a virus.

That is why a decoy server and a decoy folder are provided. An ordinary application accesses only a previously specified server or folder. Accordingly, there is a very high probability that a program accessing a virtually-formed decoy server or decoy folder is a virus. Further, confirming the access pattern, it is possible to have definite evidence of a virus. Thereafter, a computer infected with the virus is found based on the communication information. Unless the operation of the virus in the infected computer is prevented, the virus will cause damage to various computers through the network.

[Attack against Infected Computer]

The computer attack means 17 (FIG. 1) has a function of making a prescribed attack against an infected computer. The computer attack means 17 imposes a high load on an infected computer 5. In order to prevent the operation of the virus in the infected computer, there are two methods, i.e., a method of imposing a high communication load on the infected computer 5 and a method of imposing a high load on the CPU of the infected computer.

When a high communication load is imposed on the infected computer 5, traffic increases in a communication path such as the network interface 11 connecting between the network 1 and the infected computer 5, lowering greatly the transmission speed of communication from the infected computer 5 to the network 1. Accordingly, this suppresses the virus' intrusion activity going from the inside of the infected computer 5 toward other computers through the network 1. In detail, in the case of a network having a bandwidth on the 100BASE-T level, it is sufficient to send a large packet of about 5 megabytes to the infected computer. However, in this case, a load imposed on the CPU itself is not very high.

On the other hand, when a high load is imposed on the CPU of the infected computer 5, the operation speed of the virus, which tries to demolish data in the inside of the infected computer 5, is lowered very much. As a result, it is possible to prevent spreading of virus damage in the infected computer 5. For example, Ping packets are sent in large quantities and successively. As a result, the CPU becomes overloaded, preventing the operation of the virus inside the computer and suppressing spread of damage. In detail, Ping packets of 2 bytes each or so are sent in large quantities and successively. Since the CPU of the infected computer 5 is forced to control return of a response each time a packet is received, the CPU becomes overloaded.

Thus, one or both of the above-described methods may be used. Of course, any known method other than the above methods may be used to impose a high load on the infected computer.

[Attack by a Plurality of Computers]

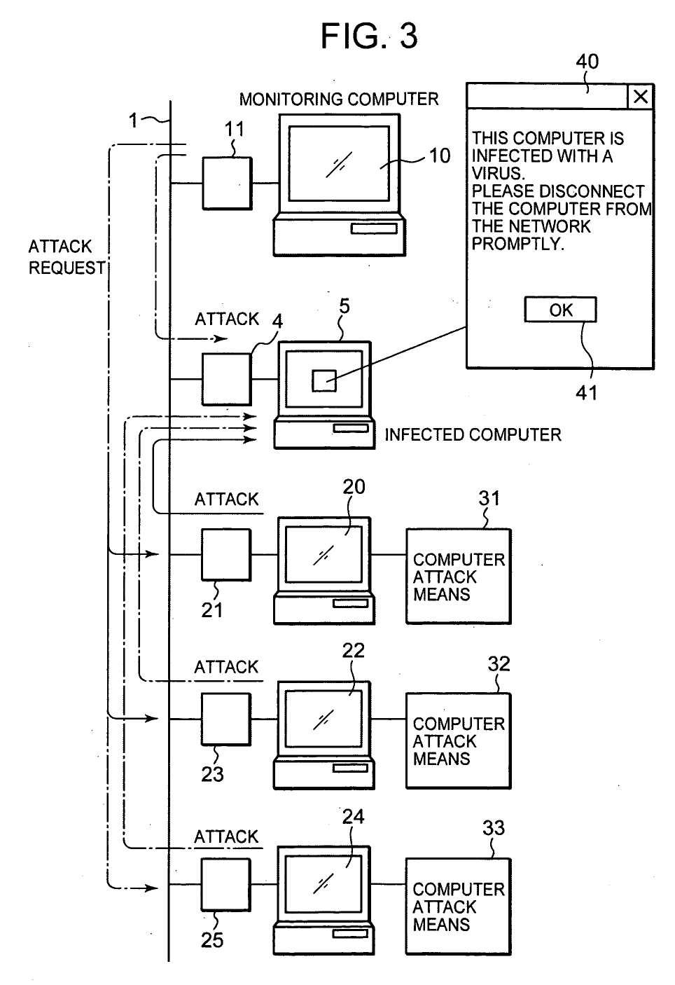

FIG. 3 is an explanatory diagram showing an example that a plurality of computers attack an infected computer 5. A network 1 shown in FIG. 3 is connected with a monitoring computer 10, an infected computer 5, and terminal units 20, 22 and 24. The terminal unit 20 is connected to the network 1 through a network interface 21. The terminal unit 22 is connected to the network 1 through a network interface 23. And, the terminal unit 24 is connected to the network 1 through a network interface 25.

The terminal unit 20 is provided with a computer attack means 31. The terminal unit 22 is provided with a computer attack means 32. And, the terminal unit 24 is provided with a computer attack means 33. Each of the computer attack means 31, 32 and 33 has a similar function to the computer attack means 17 of the monitoring computer 10.

Sometimes, one computer is insufficient to attack an infected computer. In that case, as shown in FIG. 3, the monitoring computer 10 requests other computers, for example, the terminal units 20, 22 and 24 to make an attack. Then, a plurality of computers 10, 20, 22 and 24 cooperate to attack one computer 5. By this, the computer infected with a virus is restricted in its function. Meanwhile, a notification is sent to its administrator in order to gain time for deleting the virus.

Each of the terminal units 20, 22 and 24 may be a computer dedicated to attacking or an ordinary user computer in which a computer attack means 31, 32 or 33 is installed. The network 1 may be provided with only one monitoring computer 10 or a plurality of monitoring computers 10.

An attack request sent from the monitoring computer 10 to the computer attack means 31, 32 or 33 includes the IP address (network address) of the infected computer. Favorably, an attack request includes a command for activating the computer attack means 31, 32 or 33. A computer having a computer attack means may be a computer having the same functions as the monitoring computer or a computer having the attack means only.

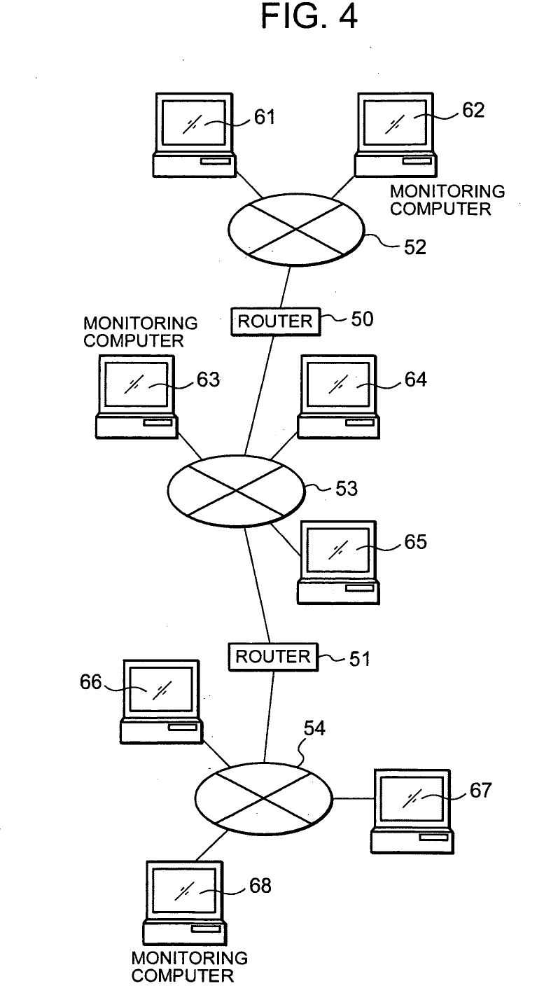

FIG. 4 is an explanatory diagram showing a large scale computer network. As shown in FIG. 4, networks 52, 53 and 54 are connected through routers 50 and 51, and each of the networks 52, 53 and 54 is connected with many computers. Between the computers 61 and 62 connected to the network 52, the computer 62 is a monitoring computer. Among the computers 63, 64 and 65 connected to the network 53, the computer 63 is a monitoring computer. And, among the computers 66, 67 and 68 connected to the network 54, the computer 68 is a monitoring computer.

For example, it is assumed that the computer 67 is an infected computer and the computer 62 detects the virus intrusion. In that case, if an attack is made by the computer 62, the routers 50 and 51 become bottlenecks and thus effective attack is difficult. Accordingly, the computer 62 requests a computer 68 to attack the computer 67. Here, the computer 68 is a computer connected to the network 54 to which the infected computer 67 belongs, and further, the computer 68 is in the neighborhood of the infected computer 67. The computer 68 gives warning through the above-described speaker or the like, to attract attention of the computer 66 etc. in the neighborhood, and then starts attacking on the computer 67. Thus, monitoring operation in a large scale network is realized.

[Operation Flowchart]

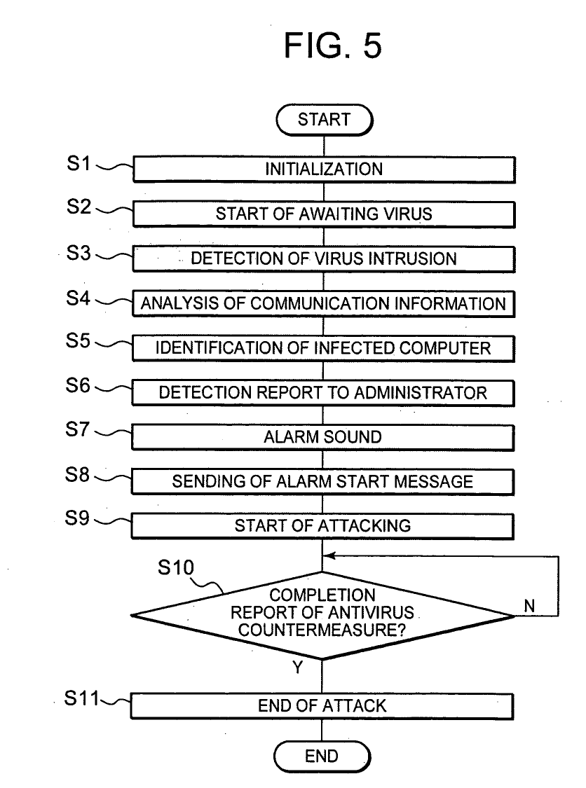

FIG. 5 is a flowchart showing basic operation of the monitoring computer. In detail, the monitoring computer 10 executes programs to realize various functions. As a result, the monitoring computer 10 functions as the communication information analysis means 16, the computer attack means 17, the detection report transmission means 18 and the alarm generation means 19.

First, the monitoring computer 10 executes an initialization procedure for making the decoy server 13, the decoy folder 14 and the decoy application effective (Step S1). In this state, virus awaiting is started (Step S2). The communication information analysis means 16 monitors communication information processed by the network interface 11.

When intrusion of a virus is detected, the communication information analysis means 16 analyzes the communication information and obtains the source IP address 8 to identify the infected computer (Steps S3, S4 and S5). The detection report transmission means 18 sends a detection report to the administrator (Step S6).

The alarm generation means 19 makes an alarm sound through the speaker 2 (Step S7). Further, the alarm generation means 19 displays a moving image or the like on the display 3 of the monitoring computer 10 to the effect that attack is now in progress. Further, the alarm generation means 19 sends an attack start message to the infected computer 5 (Step S8).

The computer attack means 17 starts attacking (Step S9). Then, it is judged whether a report to the effect of completing the antivirus countermeasure is received through any route (Step S10). In the case of receiving the report to the effect of completing the antivirus countermeasure, the attack by the computer attack means 17 is ended (Step S11).

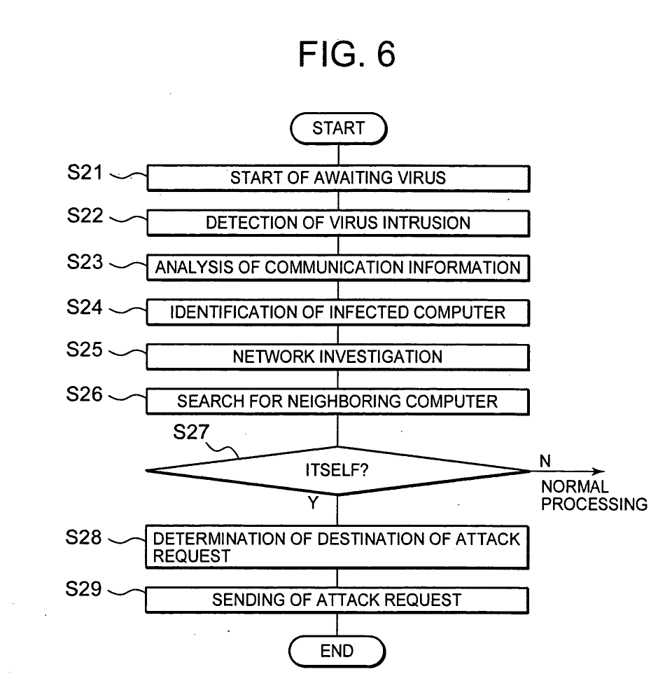

FIG. 6 is a flowchart showing cooperative operation of the monitoring computer. Also in the case where a plurality of computers cooperate in attacking on an infected computer, the above-described various functions of the monitoring computer 10 is used to perform a process of finding an infected computer, a process of making a request for cooperation in attacking, and a process of cooperative attacking.

First, the monitoring computer 10 identifies an infected computer (Steps S21-S24). The processes for identifying an infected computer are same as the processes (Steps S2-S5) shown in FIG. 5.

When the infected computer is identified, the computer attack means 17 inspects the network (Step S25). This is done for searching for a monitoring computer in the neighborhood of the infected computer. To search for the monitoring computer in the neighborhood of the infected computer, a previously-prepared list of monitoring computers is searched for a monitoring computer whose IP address partly coincides with the IP address of the infected computer (Step S26).

The monitoring computer in the neighborhood of the infected computer may be the monitoring computer itself 10 that has identified the infected computer. In the other case, the monitoring computer in the neighborhood of the infected computer is a monitoring computer that is connected to the monitoring computer 10 that has identified the infected computer through some network components such as routers, as described referring to FIG. 4. Thus, it is judged whether the monitoring computer in the neighborhood of the infected computer is the monitoring computer itself 10 that has identified the infected computer (Step S27). When it is not itself, a monitoring computer to which a request for attack is to be made is determined (Step S28). When there exist a plurality of computers that satisfy the conditions, it is sufficient to send an attack request to the plurality of computers via broadcast communication.

Next, an attack request is sent to the determined monitoring computer (Step S29). Thereafter, the processes starting from Step S6 in FIG. 5 are performed by the requested monitoring computer.

[Treatment of Infected Computer]

Since there is high probability that the infected computer has been damaged, it is the most effective countermeasure to disconnect the infected computer from the network. When this countermeasure has been completed, the attack on the infected computer can be ended.

As for the infected computer, then the virus is removed and the damaged part is repaired. Further, the OS (Operating System), applications and the like are installed again to recover the original state. For this purpose, in the storage unit 6, a screen 40 including a message to this effect is displayed on the display as shown in FIG. 3. This screen 40 is displayed until the required step is ended and the button 41 is clicked.

The present invention lowers a spreading speed of a virus of the type that spreads through a network. Namely, spreading of a virus is prevented by imposing a high load on a computer infected with the virus. Further, the present invention is suitable for the case where virus intrusion into a shared file of a computer can not be confirmed promptly based on only the activity of a virus. Namely, a decoy computer is provided such that it becomes a first target of virus' attack when a virus becomes active. By this arrangement, it is possible to find out a virus, to confirm which computer is infected with the virus, and to identify the computer that should be attacked. In other words, the present invention is effective for detecting and removing a virus that is difficult to find when the virus only intrudes into a folder.

The above-described computer programs may be realized as a combination of program modules independent from one another, or as an integrated program. All or a part of the processes controlled by the computer programs may be performed by hardware having the equivalent functions. Or, the above programs may be used being incorporated in an existing application program. The above computer programs implementing the present invention may be recorded on a computer-readable record medium such as a CD-ROM for example, and used being installed onto any information processing device. Further, the above computer programs may be used being downloaded into a memory of any computer through a network.

1. A method of preventing virus infection by detecting the virus infection in a network, comprising steps of:
providing a decoy accessible through the network to a computer that monitors intrusion of a virus;
receiving access to said decoy through the network, to obtain communication information and to detect intrusion of the virus;
detecting a virus source computer based on the communication information obtained with respect to the virus intrusion when the virus intrudes into the decoy; and
making an antivirus attack on the virus source computer through the network for suppressing operation of the virus.

2. A method of preventing virus infection according to claim 1, wherein:
said decoy is one or more of a decoy folder stored in a storage unit, a decoy application stored in the storage unit, and a server formed virtually in the storage unit.

3. A method of preventing virus infection according to claim 1, wherein:
said attack is made by imposing a high load on the virus source computer.

4. A method of preventing virus infection according to claim 3, wherein:
said high load is imposed on the virus source computer by increasing traffic of said computer.

5. A method of preventing virus infection according to claim 3, wherein:
said high load is imposed on the virus source computer by sending a large number of requests to which a CPU of said computer should respond.

6. A system for preventing virus infection by detecting the virus infection in a network, comprising:
a decoy means that can be accessed through the network;
a communication information analysis means that detects intrusion of a virus into said decoy means, and then on detecting virus intrusion, detects a virus source computer based on communication information obtained when the virus intrudes; and
a computer attack means that makes an antivirus attack on the virus source computer through the network, for suppressing operation of the virus.

7. A system for preventing virus infection according to claim 6, wherein:
said decoy means is one or more of a decoy folder stored in a storage unit, a decoy application stored in the storage unit, and a server formed virtually in the storage unit.

8. A system for preventing virus infection according to claim 6, wherein:
said computer attack means imposes a high load on the virus source computer.

9. A method of preventing virus infection in a system for preventing virus infection according to claim 8, wherein:
said computer attack means imposes the high load on the virus source computer by increasing traffic of said computer.

10. A system for preventing virus infection according to claim 8, wherein:
said computer attack means imposes the high load on the virus source computer by sending a large number of requests to which a CPU of said computer should respond.

11. A system for preventing virus infection according to one of claims 8, 9 and 10, wherein:
said system further comprises a detection report transmission means that sends a detection report to an administrator of the virus source computer; and
said computer attack means continues to make the antivirus attack on the virus source computer until a countermeasure against the virus has been completed.

12. A system for preventing virus infection according to claim 6, wherein:
said decoy means is a decoy folder realized by an application provided in a decoy server that is formed virtually in a storage unit of a computer connected to the network.

13. A system for preventing virus infection according to claim 6, wherein:
said decoy means is a decoy application realized as an application provided in a decoy server that is formed virtually in a storage unit of a computer connected to the network.

14. A system for preventing virus infection according to one of claims 8, 9 and 10, further comprising:
a message sending means that sends a message of announcing a start of the attack imposing the high load to the infected computer.

15. A system for preventing virus infection according to one of claims 8, 9 and 10, further comprising:
an alarm sound generation means that generates an alarm sound in an attacking terminal unit at a start of the attack or after the start of the attack.

16. A system for preventing virus infection according to one of claims 8, 9 and 10, further comprising:
a requesting means that notifies a network address of the virus source computer to another computer connected to the network and requests to said computer for making an antivirus attack on the virus source computer.

17. A system for preventing virus infection by detecting the virus infection in a network, comprising:
a request receiving means that receives a request for making an antivirus attack on a virus source computer; and
a computer attack means that makes an antivirus attack on said virus source computer through the network for suppressing operation of a virus, based on said request received.

18. A program for making a computer prevent virus infection by detecting the virus infection in a network, wherein:
said program makes said computer realize:
a communication information analysis means that detects intrusion of a virus into a decoy means accessible through the network, and then on detecting virus intrusion, detects a virus source computer based on communication information obtained when the virus intrudes; and
a computer attack means that makes an antivirus attack on the virus source computer through the network, for suppressing operation of the virus.

19. A program for making a computer prevent virus infection by detecting the virus infection in a network, wherein:
said program makes said computer perform processing of rejecting communication from a virus source computer when a network address of the virus source computer is notified.
